(19) United States
(12) Patent Application Publication
(10) Pub. No.: US 2006/0018498 A1
(43) Pub. Date: Jan. 26, 2006

(54) Hearing aid component for mobile telecommunication terminals

(76) Inventor: Michael Hulskemper, Hunxe (DE)

Correspondence Address: BELL, BOYD & LLOYD, LLC, P. O. BOX 1135, CHICAGO, IL, 60690-1135, US

(21) Appl. No.: 11/190,717

(22) Filed: Jul. 26, 2005

(30) Foreign Application Priority Data
Jul. 26, 2004 (DE) 10 2004 036 255.6

(51) Int. Cl. H04R 25/00

(52) U.S. Cl. 381/331

(57) ABSTRACT

A hearing aid component having a coil which is designed for inductive coupling to a hearing aid coil, where the hearing aid component has an audio connection for receiving audio signals, and also to a combination including the disclosed hearing aid component and a mobile communication terminal.

### FIELD OF TECHNOLOGY

The present disclosure relates to a hearing aid component having a coil which is designed for inductive coupling to a hearing aid coil. To allow mobile communication terminal users with impaired hearing to communicate, “HAC” coils are used, with the hearing aid component in such a case being formed by the coil itself. In this context, the abbreviation “HAC” stands for “Hearing Aid Compatibility”.

### BACKGROUND

HAC coils are normally fitted onto a frame of an earpiece on a mobile communication terminal and are usually operated in electrical parallel with an earpiece oscillating coil.

In this case, it is considered to be a drawback that the electromechanical design of the earpiece oscillating coil, which acts as a loudspeaker, influences the properties of the HAC coil, since it acts as a coil core.

Moreover, equipping mobile communication terminals with hearing aid components is currently a hot topic in the USA, since new legal provisions prescribe that manufacturers of mobile communication terminals are obliged to have at least two mobile communication terminals in a product range which meet specific HAC demands. Relevant stipulations are set out in the “Hearing Aid Compatibility Act” of 1988.

Against this background, the present disclosure provides a hearing aid component that is suitable for expediently upgrading mobile communication terminals, and also of specifying an associated combination comprising a hearing aid component and a mobile communication terminal.

### BRIEF SUMMARY

The above mentioned features are embodied in a hearing aid component having an audio connection for receiving audio signals. This allows the hearing aid component to be connected to mobile communication terminals which have an appropriate audio output. The hearing aid component can be connected directly to a mobile communication terminal or suitable adapters can be provided which support such a connection.

The audio connection is preferably in the form of an interface. In this case, this interface's design may match usual interfaces on mobile communication terminals. The specific choice of interface is down to the preference of the person skilled in the art. It is merely necessary to ensure that connection to an audio output on a mobile communication terminal is made possible.

In one exemplary embodiment, the hearing aid component is in the form of a clip-on cover for a mobile communication terminal, with the coil of the hearing aid component preferably being connected in parallel with a sound transducer. The clip-on cover thus integrates the HAC coil and the sound transducer (loudspeaker). In this case, the HAC coil and the sound transducer can be connected in parallel. Alternatively, the clip-on cover can also have a separate pair of contacts which form the audio connection and interact with an associated connection on the mobile communication terminal for outputting audio signals.

This allows a very large number of mobile communication terminals to be subsequently retrofitted with an HAC coil.

In cases where the hearing aid component is connected to a mobile communication terminal via an interface and in the case of the embodiment as a clip-on cover, provision is made for the hearing aid component not to be integrated into the mobile communication terminal directly under an exemplary embodiment. Rather, the hearing aid component is an accessory which can be used to retrofit mobile communication terminals.

A mobile communication terminal and a hearing aid component of the type described above is disclosed, in which the mobile communication terminal has an audio output connection which matches the audio connection of the hearing aid component. Preferably, the mobile communication terminal has an interface for the audio output connection which matches an interface on the hearing aid component.

In this case, the audio output connection of the mobile communication terminal may preferably be provided by a multifunctional connection. On many mobile communication terminals, there is an “accessories/charging interface” which already provides audio signals for optional headsets or car kits. This very interface can be configured to interact with the hearing aid component.

Preferably, the mobile communication terminal is provided with an audio operating profile which matches acoustic properties of the hearing aid component. In this respect, the mobile communication terminal has a particular HAC operating profile, which can be set up by updating the firmware of the mobile communication terminal, for example.

It is advantageous if the mobile communication terminal has an active driver stage for an inductive load for the hearing aid component's coil. This also allows a power supply to be provided for the hearing aid component. However, it is assumed that the high impedance of the hearing aid component's coil means that it is possible to dispense with such an active driver stage in most instances of application.

In the case of an integrated embodiment, provision may be made for the hearing aid component to be integrated in the mobile communication terminal, preferably its top shell, and to be arranged at a distance from a loudspeaker in the mobile communication terminal, and for the audio connection to be connected directly to an audio output on a circuit board in the mobile communication terminal. In the case of this embodiment, the hearing aid component is incorporated in the mobile communication terminal, with direct contact being made with the coil on the circuit board. In this case, the audio connection of the hearing aid component is formed by the coil contacts themselves.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a schematic illustration of a hearing aid component based on an exemplary embodiment in combination with a mobile communication terminal and a hearing aid; and

FIG. 2 is a schematic illustration of a hearing aid component based on a second exemplary embodiment in combination with a mobile communication terminal and a hearing aid.

### DETAILED DESCRIPTION

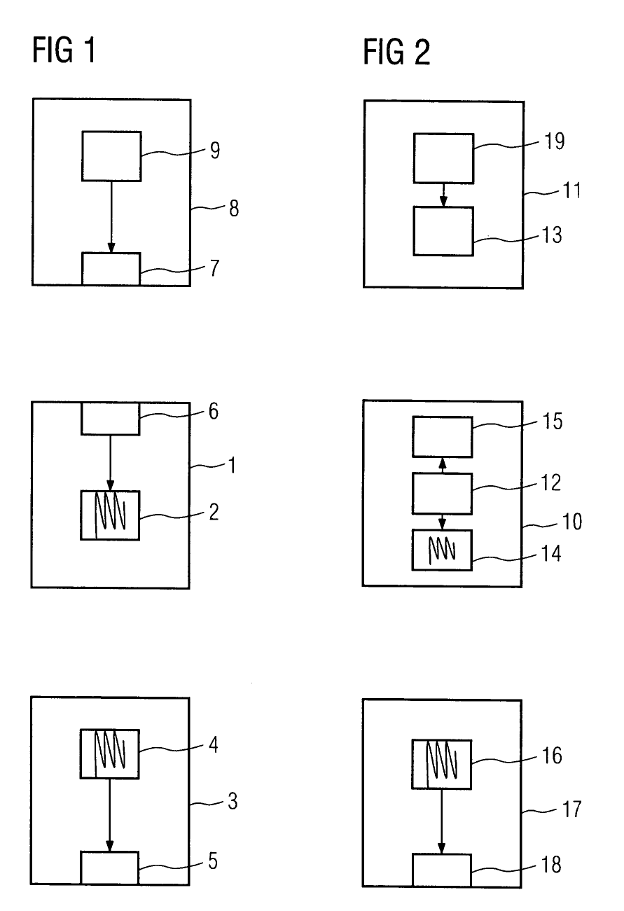

FIG. 1 illustrates a first exemplary embodiment of a hearing aid component 1, where a hearing aid coil (HAC coil) 2 is used for inductive coupling to a hearing aid 3. The hearing aid 3 is also equipped with a coil 4, so that audio signals can be transmitted from the hearing aid coil 2 to the coil 4 through inductive coupling. The hearing aid 3 itself contains a loudspeaker 5 which reproduces the audio signals received via the coil 4 for a user of the hearing aid 3.

The hearing aid component I receives the audio signals to be transmitted via the hearing aid coil 2 from an interface 6 which is adapted to interact with a multifunctional interface 7 on a mobile communication terminal 8, particularly a mobile telephone. The multifunctional interface 7, which can also be called a multifunctional connection, is connected to a central control device 9 in the mobile communication terminal 8. The central control device 9 can be provided on a baseband chip in the mobile communication terminal 8, for example.

The multifunctional interface 7 may be a combined accessories/charging interface which, in the case of the mobile communication terminal 8, is designed for connecting external appliances, such as headphones or a motor vehicle hands-free device, or else a charger. The multifunctional interface 7 has contacts which are connected to a power supply for the mobile communication terminal 8. In this way, the hearing aid component 1 can be supplied with voltage via the multifunctional interface 7 and the interface 6, and, if required, the hearing aid component has a separate driver stage for providing the suitable operating voltage for the hearing aid component.

FIG. 2 illustrates a second exemplary embodiment of a hearing aid component 10. The hearing aid component 10 has the general form of a clip-on cover and may have universally useable mounting devices for fitting to different mobile communication terminals, such as mobile telephones. In the embodiment of FIG. 2, the external shape of the clip-on cover 10 matches an external shape of an associated mobile telephone 11. The clip-on cover 10 may also be provided as an interchangeable top shell of a mobile telephone.

The clip-on cover 10 has an audio connection 12 which is connected to an associated audio connection 13, for example via contact springs, when the hearing aid component 10 is fitted on the mobile communication terminal 11. As in the preceding exemplary embodiment, the audio connection 12 may additionally be used to provide an operating voltage for a hearing aid coil 14. The hearing aid coil 14 is connected in parallel with a sound transducer 15 (loudspeaker), so that the sound transducer 15 does not act as a coil core for the hearing aid coil 14. In particular, inductive transmission of audio signals from the hearing aid coil 14 to a coil 16 in a hearing aid 17 is not influenced. A branch from the audio connection 12 to the coil 14 is situated upstream of an equalization stage for the loudspeaker 15, so that an independent use profile can be set for the coil. Such a use profile can be activated whilst stored on a baseband chip in the mobile communication terminal using the coil 14.

As in the preceding exemplary embodiment, the audio signals are inductively transmitted via the coils 14, 16 to a loudspeaker 18 in the hearing aid 17.

The audio signals to be emitted are provided by a central control device 19 which is connected to the audio connection 13 of the mobile communication terminal 11.

It should be noted that the clip-on cover 10 does not necessarily have to contain the sound transducer 15 and the hearing aid coil 14. Rather, just the hearing aid coil 14 may be provided as the audio signal transmission device for the clip-on cover 10. In this case of an alternative embodiment, contact springs for the audio connection 12 are used exclusively to transmit audio signals to the hearing aid coil 14.

A common feature of both embodiments of the invention which have been explained above is that they can be used “externally” particularly for a mobile telephone as communication terminal, which means that the hearing aid coil 2 or 14 can be retrofitted to mobile telephones.

In a further embodiment of the invention, an integrated solution is provided for the combination comprising a hearing aid component and a mobile communication terminal. This embodiment has no particular figure dedicated to it. However, with reference to FIG. 2, the clip-on cover (10) is essentially replaced by a top shell of the mobile communication terminal. This top shell contains the hearing aid coil at a distance from the loudspeaker (as a departure from the prior art), with structural decoupling being achieved between the loudspeaker, on the one hand, and the hearing aid coil, on the other. The coil of the hearing aid component has contact made with it directly on a circuit board in the mobile communication terminal, specifically at a suitable audio output.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A hearing aid component comprising:
a coil, inductively coupled to a hearing aid coil, wherein the hearing aid component has an audio connection for receiving audio signals.

2. The hearing aid component as claimed in claim 1, wherein the audio connection is in the form of an interface.

3. The hearing aid component as claimed in claim 1, wherein the component is in the form of a clip-on cover for a mobile communication terminal.

4. The hearing aid component as claimed in claim 3, wherein the coil of the hearing aid component is connected in parallel with a sound transducer integrated in the clip-on cover.

5. The hearing aid component as claimed in claim 1, further comprising:
a mobile communication terminal, wherein the mobile communication terminal has an audio output connection which matches the audio connection of the hearing aid component.

6. The hearing aid component as claimed in claim 5, wherein the audio output connection of the mobile communication terminal is formed by a multifunctional connection.

7. The hearing aid component as claimed in claim 5, wherein the mobile communication terminal is provided with an audio operating profile which matches acoustic properties of the hearing aid component.

8. The hearing aid component as claimed in claim 5, wherein the hearing aid component has an active driver stage for an inductive load for the coil.

9. The hearing aid component as claimed in claim 5, wherein the hearing aid component is integrated in the mobile communication terminal and is arranged at a distance from a loudspeaker in the mobile communication terminal, and the audio connection is connected directly to an audio output on a circuit board in the mobile communication terminal.

10. The hearing aid component as claimed in claim 5, wherein the hearing aid component is arranged in a top shell of the mobile communication terminal.
